(19) United States
(12) Patent Application Publication
(10) Pub. No.: US 2008/0030844 A1
(43) Pub. Date: Feb. 7, 2008

(54) Electrophoretic display device

(75) Inventors: Uk Chul Choi, Chungcheongnam-do (KR); Cheol Woo Park, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/888,460

(22) Filed: Jul. 31, 2007

(30) Foreign Application Priority Data
Aug. 1, 2006 (KR) 10-2006-0072543

(51) Int. Cl. G02B 26/00

(52) U.S. Cl. 359/296

(57) ABSTRACT

An electrophoretic display device having a first array substrate including a first substrate, a common electrode formed on the first substrate, and a plurality of micro capsules containing first pigments with a positive polarity and second pigments with a negative polarity. A second array substrate is provided, the second array substrate including a second substrate facing the first substrate. The second substrate includes gate and data lines, a thin film transistor connected to the gate and data lines, a pixel electrode connected to the thin film transistor, and first and second spaced-apart conductive touch spacers which extend toward the first substrate.

### CROSS-REFERENCE TO RELATED APPLICATION

This application claims priority to and the benefit of Korean Patent Application No. 10-2006-72543, filed Aug. 1, 2006, the disclosure of which is incorporated herein by reference in its entirety.

### BACKGROUND OF THE INVENTION

1. Field of the Invention

The present invention relates to an electrophoretic display device and, more particularly, to an electrophoretic display device which can detect an input location selected by a user.

2. Description of the Related Art

An electrophoretic display device comprises micro capsules which contain an electronic ink with black and white pigments charged with a positive polarity and a negative polarity. The electrophoretic display device displays an image such that locations of black and white pigments are changed by an electric field. Compared to a liquid crystal display (LCD) device, the electrophoretic display device is high in reflectivity and contrast ratio and is independent of a viewing angle, and thus a user can comfortably see a displayed image like paper. In addition, the electrophoretic display device has low power consumption since it has bistable characteristics of black and white and it can maintain an image without continuously applying a voltage.

However, when a touch panel is arranged outside the electrophoretic display device, a first substrate of the electrophoretic display device made of a flexible material such as plastic does not endure a load of the touch panel.

### SUMMARY OF THE INVENTION

The present invention has been made in an effort to solve the above problems, and it is an object of the present invention to provide an electrophoretic display device which can detect an input location selected by a user.

In an exemplary embodiment of the present invention, an electrophoretic display device comprises a first array substrate comprising a first substrate, a common electrode formed on the first substrate, and a plurality of micro capsules containing first pigments with a positive polarity and second pigments with a negative polarity, and a second array substrate comprising a second substrate facing the first substrate, the second substrate including, gate and data lines, a thin film transistor connected to the gate and data lines, a pixel electrode connected to the thin film transistor, and first and second spaced apart conductive touch spacers which extend toward the first substrate.

The electrophoretic display device further comprises first and second touch conductive lines connected respectively to the first and second conductive touch spacers.

The first and second touch conductive lines are formed in parallel to each other, or formed to cross each other to be insulated from each other.

In one exemplary embodiment of the present invention, the first and second conductive touch spacers have in a first plane predetermined widths at a base thereof, and wherein the widths in the first plane become narrower as the first and second conductive touch spacers extend toward the first substrate.

The narrowing width is defined in a stair-step construction.

In another exemplary embodiment of the present invention, each of the first and second conductive touch spacers includes a support portion connected to each of the first and second touch conductive lines, and a contact portion which extends from on the support portion, and further wherein the contact portion has a width which becomes narrower gradually as the contact portion extends toward the first substrate.

Materials for the first and second conductive touch spacers are selected from the group consisting of as molybdenum (Mo), aluminum (Al), tungsten (W), or silver (Ag).

In one exemplary embodiment of the present invention, the first and second conductive touch spacers are used to detect a change in a resistance value of the touch position of a user for the first substrate.

In another exemplary embodiment of the present invention, the first and second conductive touch spacers are used to detect a change in a capacitance value of the touch position of a user for the first substrate.

In still another exemplary embodiment of the present invention, the first and second conductive touch spacers are used to detect a change in a magnetic value of the touch position of a user for the first substrate.

In an exemplary embodiment of the present invention, an electrophoretic display device comprises a first array substrate comprising a first substrate, a common electrode formed on the first substrate, and a plurality of micro capsules containing first pigments with a positive polarity and second pigments with a negative polarity, and a second array substrate comprising a second substrate facing the first substrate, the second substrate including, gate and data lines, a thin film transistor connected to the gate and data lines, a pixel electrode connected to the thin film transistor, and first and second touch conductive lines wherein the first touch conductive line is electrically connected to a first touch spacer, and the second conductive line is electrically connected to a second touch spacer.

### BRIEF DESCRIPTION OF THE DRAWINGS

The above and other features of the present invention will be described in reference to certain exemplary embodiments thereof with reference to the attached drawings in which:

FIG. 1A is a plan view illustrating a first panel for an electrophoretic display device according to an exemplary embodiment of the present invention;

FIG. 1B is a plan view of a second panel for the electrophoretic display device;

FIG. 2 is a cross-sectional view taken along line I-I′ of FIGS. 1A and 1B;

FIG. 3 is a plan view illustrating another electrophoretic display panel according to another embodiment of the present invention;

FIGS. 4A and 4B are cross-sectional views illustrating a location where first and second touch spacers are formed according to an exemplary embodiment of the present invention;

FIGS. 5A to 5C are perspective views showing various shapes of the first and second touch spacers according to an exemplary embodiment of the present invention;

FIG. 6 is a perspective view illustrating a touch by a user of the first and second touch spacers according to an exemplary embodiment of the present invention;

FIGS. 7A and 7B are block diagrams illustrating driving devices for driving the electrophoretic display panel according to an exemplary embodiment of the present invention; and

FIG. 8 is a perspective view illustrating a drive principle of an electrophoretic display panel which is driven in an electromagnetic inductive method according to an exemplary embodiment of the present invention.

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below in order to explain the present invention by referring to the figures.

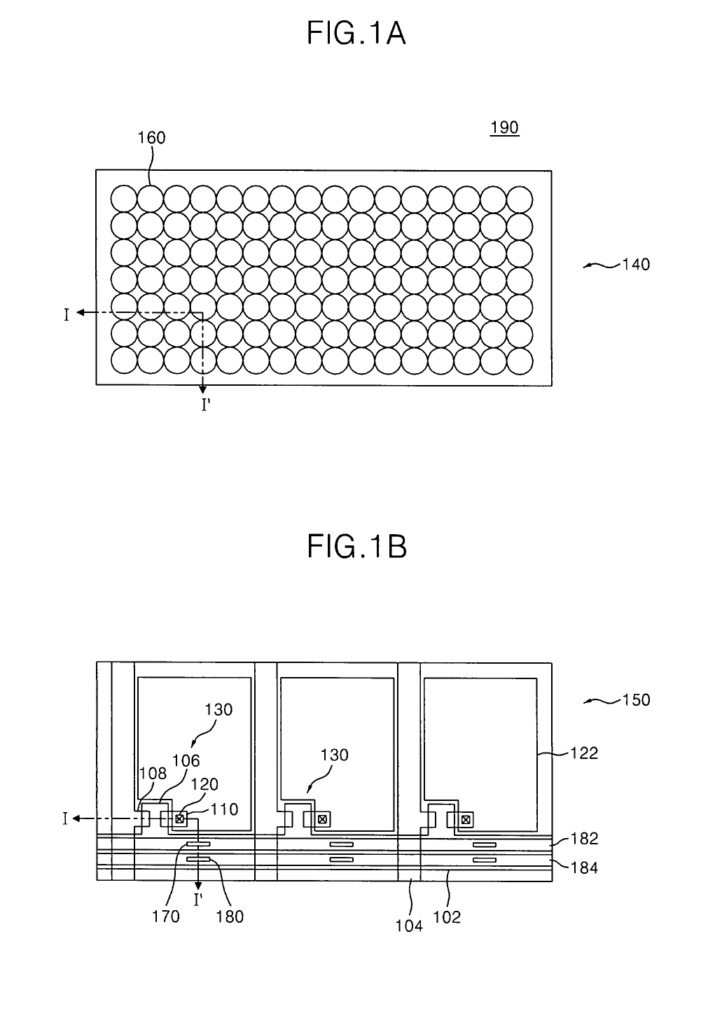

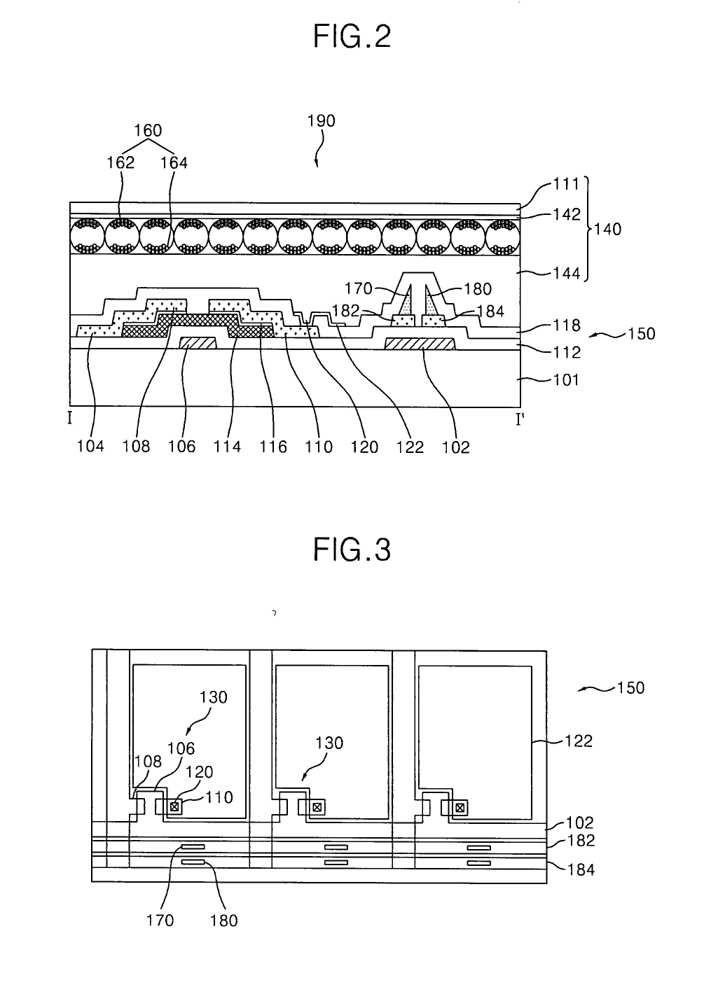

FIGS. 1A and 1B are plan views illustrating an electrophoretic display panel according to an exemplary embodiment of the present invention, and FIG. 2 is a cross-sectional view taken along line I-I′ of FIGS. 1A and 1B.

As shown in FIGS. 1A, 1B and 2, an electrophoretic display panel 190 comprises first and second array substrates 140 and 150. The first array substrate 140 comprises a first substrate 111, a common electrode 142 formed on the first substrate 111 to form an electric field with a pixel electrode 122, a plurality of micro capsules 160 formed on the common electrode 142 to realize black/white or color contrast, and an adhesive layer 144 formed over the whole surface of the first substrate 111 to cover the plurality of micro capsules 160.

The first substrate 111 is made of a flexible material with an elasticity such as that of plastic.

The common electrode 142 is made of a transparent conductive material and formed on the first substrate 111. The common electrode 142 forms an electric field with the pixel electrode 122 to drive pigments 162 with a positive polarity and pigments 164 with a negative polarity.

Each of a plurality of micro capsules 160 contains an electronic ink with a black pigment 162 with a positive polarity and a white pigment 164 with a negative polarity. The pigments 162 with a positive polarity and the pigments 164 with a negative polarity respectively move to the pixel electrode 122 and the common electrode 142 which have an opposite polarity thereto when an electric potential difference occurs between the pixel electrode 122 and the common electrode 142. For example, if a pixel voltage with a positive polarity is applied to the pixel electrode 122 and a common voltage with a negative polarity is applied to the common electrode 142, the pigments 162 with a positive polarity move to the common electrode 142, and the pigments 164 with a negative polarity move to the pixel electrode 122, whereby the pigments 162 with a positive polarity and the pigments 164 with a negative polarity are separated from each other. Accordingly, images of black and white are realized through the electrophoretic display panel 190.

The adhesive layer 144 serves to adhere the first array substrate 140 to the second array substrate 150.

The second array substrate 150 comprises gate lines 102 arranged in a transverse direction, data lines 104 arranged in a perpendicular direction to the gate lines 102, thin film transistors (TFTs) 130 connected to the gate lines 102 and the data lines 104, a pixel electrode 122 electrically connected to the TFT 130, first and second touch conductive lines 182 and 184 which detect the coordinate of a location selected by a user, a first conductive touch spacer 170 formed on the first touch conductive line 182, and a second conductive touch spacer 180 formed on the second touch conductive line 184.

The TFT 130 selectively supplies a pixel voltage to the pixel electrode 122 from the data line 104 in response to a gate signal transmitted from the gate line 102. To this end, the TFT 130 comprises a gate electrode 106 connected to the gate line 102, a source electrode 108 connected to the data line 104, a drain electrode 110 connected to the pixel electrode 122, an active layer 114 for forming a channel between the source electrode 108 and the drain electrode 110 while overlapping the gate electrode 106 with a gate insulating layer 112 disposed therebetween, and an ohmic contact layer 116 for an ohmic contact between the active layer 114 and the source and drain electrodes 108 and 110.

The pixel electrode 122 is formed on a passivation layer 118 and electrically connected to the drain electrode 110 exposed via a contact hole 120. The pixel electrode 122 uses the pixel voltage supplied through the TFT 130 to generate an electric potential difference with the common voltage supplied to the common electrode 142.

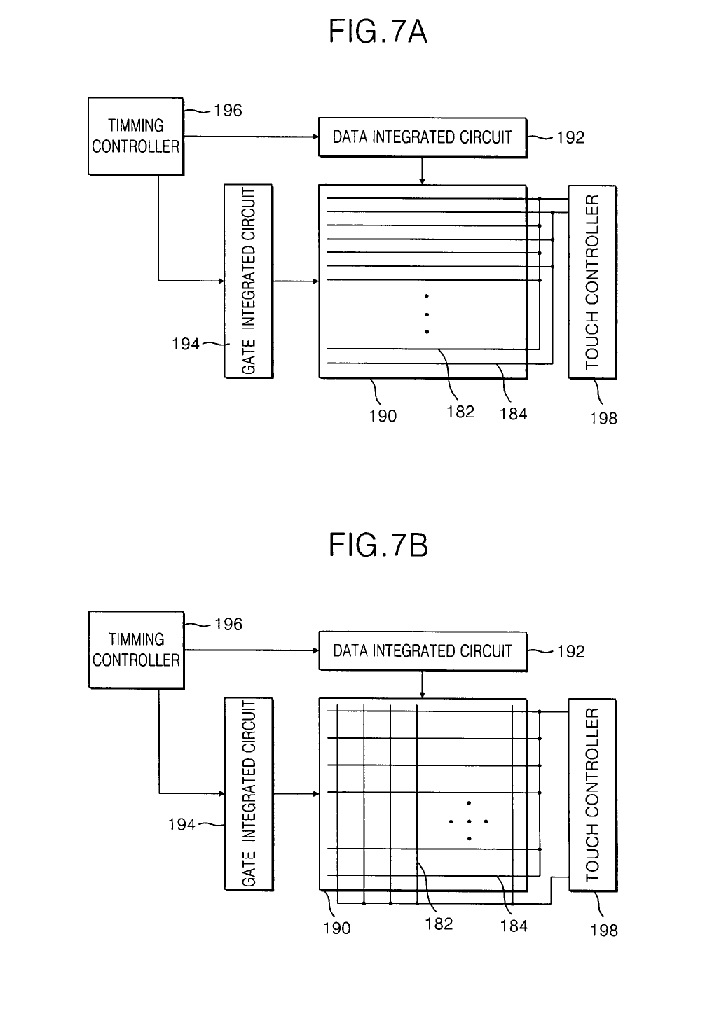

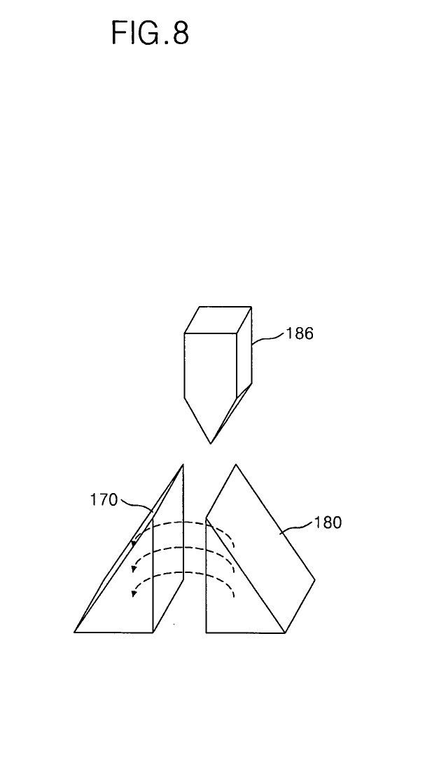

The first and second touch conductive lines 182 and 184 may be formed over the gate line 102 in the same direction as the gate line 102 or may be formed over the data line 104 in the same direction as the data line 104. Alternatively, as shown in FIG. 3, the first and second touch conductive lines 182 and 184 may be formed adjacent to the gate line 102 or the data line 104. Also, as shown in FIG. 7B, the first and second touch conductive lines 182 and 184 may be formed to cross each other to output an X and Y coordinate signals.

At this time, the first and second touch conductive lines 182 and 184 are insulated from each other.

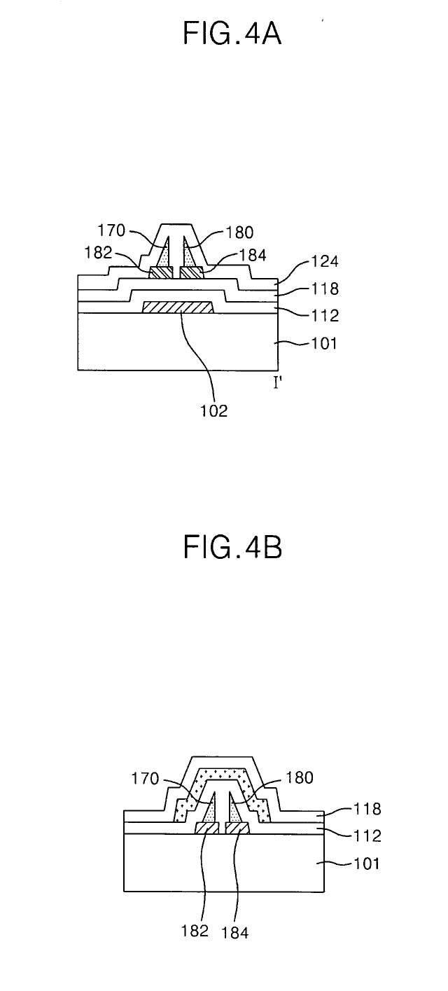

In case where the first and second touch conductive lines 182 and 184 are formed over the gate line 102 in the same direction as the gate line 102, the first and second touch conductive lines 182 and 184 may be formed on the gate insulating layer 112 using the same material as the data line 104 as shown in FIG. 2 or may be formed on the passivation layer 118 using low resistance metal as shown in FIG. 4A.

In case where the first and second touch conductive lines 182 and 184 are formed over the data line 104 in the same direction as the data line 104, the first and second touch conductive lines 182 and 184 may be formed on the second substrate 101 using the same material as the gate line 102 as shown in FIG. 4B or may be formed on the passivation layer 118 using low resistant metal.

The first conductive touch spacer 170 is formed on the first touch conductive line 182, and the second conductive touch spacer 180 is formed on the second touch conductive line 184. Thus, the first and second conductive touch spacers 170 and 180 are separated from each other, facing each other in a transverse direction. The first and second conductive touch spacers 170 and 180 are apart from each other by a relatively short distance “d”, e.g., 10 μm to 20 μm so that the first and second conductive touch spacers 170 and 180 can contact each other by pressure generated by a pen or a finger. The first and second conductive touch spacers 170 and 180 have the elasticity that they are easily bent by the pressure generated by a pen or a finger and are easily recovered to the original state.

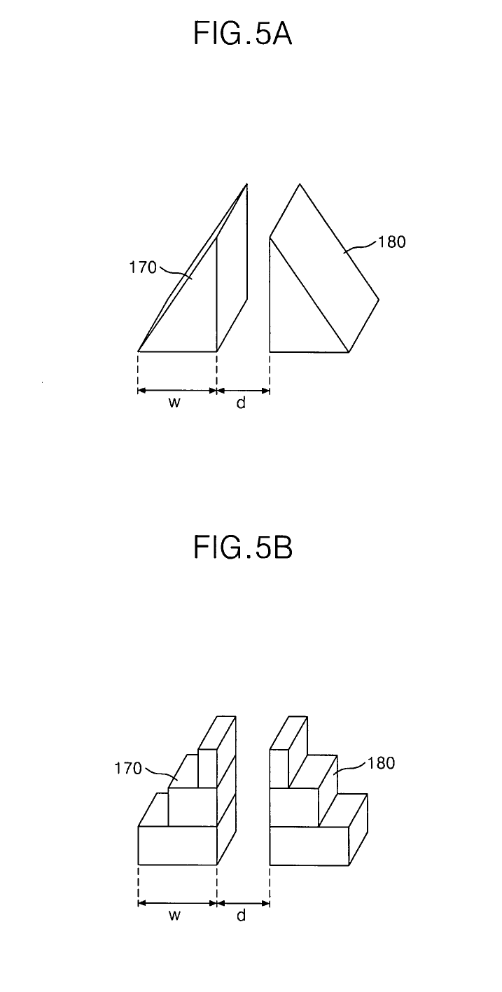

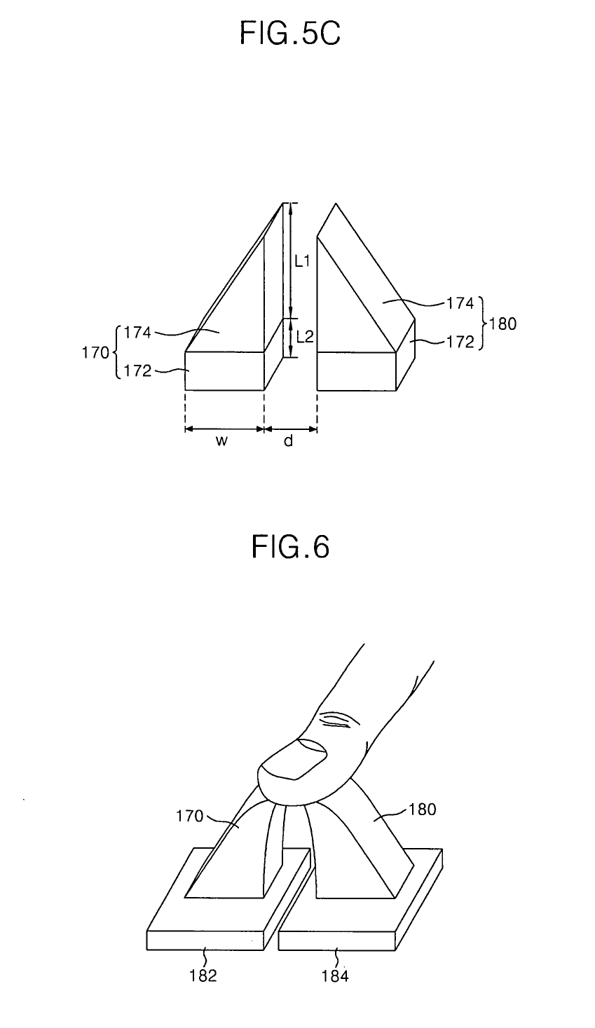

To this end, the first and second conductive touch spacers 170 and 180 may be shaped such that their widths become narrower as they extend toward the first substrate 111 from the first and second touch conductive lines 182 and 184 while maintaining the separation distance “d”, as shown in FIGS. 5A to 5C.

In more detail, referring to FIG. 5A, the first and second conductive touch spacers 170 and 180 may have a right-angled triangular-shaped cross section. Also, the first and second conductive touch spacers 170 and 180 may have a stairs-shaped cross section as shown in FIG. 5B.

Alternatively, as shown in FIG. 5C, each of the first and second conductive touch spacers 170 and 180 may comprise a support portion 172 and a contact portion 174. The support portions 172 of the first and second conductive touch spacers 170 and 180 contact the first and second touch conductive line 182 and 184. The contact portions 174 of the first and second conductive touch spacers 170 and 180 have a right-angled triangular-shaped cross section. Preferably, the length L1 of the contact portion 174 is longer than the length L2 of the support portion 172, and the maximum width of the contact portion 174 are equal to the width W of the support portion 172.

The upper portions of the first and second conductive touch spacers 170 and 180 have relatively narrow widths and accordingly have a high elasticity. The upper portions of the first and second conductive touch spacers 170 and 180 with the narrow width are easily bent by the pressure of the pen or the finger and easily are recovered to the original state. The lower portions of the first and second conductive touch spacers 170 and 180 have relatively wide widths and so stably support and fix the first and second conductive touch spacers 170 and 180.

The first and second touch conductive spacers 170 and 180 are formed using an etching technique, preferably a dry etching technique. Preferably, the first and second conductive touch spacers 170 and 180 are made of metal suitable for a dry-etching such as molybdenum (Mo), aluminum (Al), tungsten (W), and silver (Ag).

As described above, the first and second conductive touch spacers 170 and 180 contact each other, as shown in FIG. 6, when a pen or a finger of a user presses the first substrate 111.

At this time, a resistance value of a location where the first and second conductive touch spacers 170 and 180 contact varies differently from other positions. The electric current or voltage varies depending on the varied resistance value, and the electrophoretic display panel 190 outputs the varied electric current or voltage as a coordinate signal through the first and second touch conductive lines 182 and 184.

A touch controller 198 shown in FIGS. 7A and 7B receives the coordinate signal of a touch position from the electrophoretic display panel 190 to compute a coordinate value and supplies it to a system (not shown). The touch controller 198 may be arranged separately or may be built in a gate integrated circuit 194 for driving the gate line 102, a data integrated circuit 192 for driving the data line 104, or a timing controller 196 for controlling the gate and data integrated circuits 194 and 192. The system performs a corresponding command or executes a related application program.

The electrophoretic display panel described above detects the coordinate of the touch position by using the resistive method, but the present invention is not limited to the resistive/conductive method and may use different methods such as the capacitive or electromagnetic inductive method to detect the coordinate of the touch position.

For example, in case of the capacitive method, the touch spacers may not make contact, but may change in separation distance when a finger of a user or a pen touches the first substrate. The capacitance value at the touch position then varies differently from other positions. The electrophoretic display panel outputs the varied voltage depending on the varied capacitance value as a coordinate signal through the first and second touch conductive lines 182 and 184.

In case of the electromagnetic inductive method, an alternating current (AC) signal is applied to the first and second touch conductive lines 182 and 184 used as a coil, and then an electronic pen having a resonance circuit comprised of a coil and a capacitor touches the first substrate 111 of the electrophoretic display panel 190 as shown in FIG. 8. The first and second conductive touch spacers 170 and 180 form a magnetic field at the touch position, and the magnetic field is induced in an electronic pen 186. The induced magnetic field is stored in the electronic pen 186, and the electronic pen 186 generates a resonant frequency to be outputted as a coordinate signal.

As described above, the electrophoretic display device of the present invention includes the first and second conductive touch spacers which face each other in a transverse direction and are arranged in the electrophoretic display panel. The electrophoretic display device of the present invention can detect the touch position of the user through the first and second touch conductive lines connected to the first and second touch spacers.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. An electrophoretic display device comprising:
a first array substrate comprising a first substrate, a common electrode formed on the first substrate, and a plurality of micro capsules containing first pigments with a positive polarity and second pigments charged with a negative polarity; and
a second array substrate comprising a second substrate facing the first substrate, the second substrate including, gate and data lines, a thin film transistor connected to the gate and data lines, a pixel electrode connected to the thin film transistor, and first and second sp aced apart conductive touch spacers which extend toward the first substrate.

2. The electrophoretic display device of claim 1, further comprising first and second touch conductive lines connected respectively to the first and second conductive touch spacers.

3. The electrophoretic display device of claim 2, wherein the first and second touch conductive lines are formed in parallel to each other, or formed to cross each other to be insulated from each other.

4. The electrophoretic display device of claim 1, wherein the first and second conductive touch spacers have in a first plane predetermined widths at a base thereof, and wherein the widths in the first plane become narrower as the first and second conductive touch spacers extend toward the first substrate.

5. The electrophoretic display device according to claim 4 wherein the narrowing width is defined in a stair-step construction.

6. The electrophoretic display device of claim 2, wherein each of the first and second conductive touch spacers includes a support portion connected to each of the first and second touch conductive lines, and a contact portion which extends from on the support portion, and further wherein the contact portion has a width which becomes narrower gradually as the contact portion extends toward the first substrate.

7. The electrophoretic display device of claim 1, wherein materials for the first and second conductive touch spacers are selected from the group consisting of as molybdenum (Mo), aluminum (Al), tungsten (W), or silver (Ag).

8. The electrophoretic display device of claim 1, wherein the first and second conductive touch spacers are used to detect a change in a resistance value of the touch position of a user for the first substrate.

9. The electrophoretic display device of claim 1, wherein the first and second conductive touch spacers are used to detect a change in a capacitance value of the touch position of a user for the first substrate.

10. The electrophoretic display device of claim 1, wherein the first and second conductive touch spacers are used to detect a change in a magnetic value of the touch position of a user for the first substrate.

11. An electrophoretic display device comprising:
a first array substrate comprising a first substrate, a common electrode formed on the first substrate, and a plurality of micro capsules containing first pigments with a positive polarity and second pigments charged with a negative polarity; and
a second array substrate comprising a second substrate facing the first substrate, the second substrate including, gate and data lines, a thin film transistor connected to the gate and data lines, a pixel electrode connected to the thin film transistor, and first and second touch conductive lines wherein the first touch conductive line is electrically connected to a first touch spacer, and the second conductive line is electrically connected to a second touch spacer.

12. The electrophoretic display device of claim 11, wherein the first and second touch conductive lines are formed in parallel to each other, or formed to cross each other to be insulated from each other.

13. The electrophoretic display device of claim 11, wherein the first and second touch spacers have in a first plane predetermined widths at a base thereof, and wherein the widths in the first plane become narrower as the first and second touch spacers extend toward the first substrate.

14. The electrophoretic display device of claim 13, wherein the narrowing width is defined in a stair-step construction.

15. The electrophoretic display device of claim 11, wherein each of the first and second touch spacers includes a support portion connected to each of the first and second touch conductive lines, and a contact portion which extends from on the support portion, and further wherein the contact portion has a width which becomes narrower gradually as the contact portion extends toward the first substrate.
